(19) United States
(12) Patent Application Publication
(10) Pub. No.: US 2026/0038313 A1
(43) Pub. Date: Feb. 5, 2026

(54) Charging Connection Simulator Plug and Vehicle

(71) Applicant: Total Safety Solutions B.V., Oisterwijk (NL)

(72) Inventors: Hendricus Johannes Bernardus Wijnans, Oisterwijk (NL); Ralf Arnoldus Antonius Adams, Oisterwijk (NL)

(21) Appl. No.: 19/355,347

(22) Filed: Oct. 10, 2025

Related U.S. Application Data
(63) Continuation of application No. PCT/NL2023/050342, filed on Jun. 19, 2023.

(30) Foreign Application Priority Data
Apr. 11, 2023 (NL) 2034533

(51) Int. Cl. G07C 5/08; B60L 3/00; B60L 53/16

(52) U.S. Cl. CPC G07C 5/0808; B60L 3/0023; B60L 53/16; G07C 5/0825; G07C 5/0833

(57) ABSTRACT

A charging connection simulator plug for fitting an external electric charging port of an electric vehicle, wherein the plug is designed for simulating a connection to a charging station through its electrical contacts by comprising an electrical resistance associated with its PP and/or PE contact, and a circuit for CP communications associated with its CP contact, for generating Pulse-width modulation signals, wherein the plug is fully incompatible with the charging of the electrical vehicle.

### CROSS-REFERENCE TO RELATED APPLICATIONS

This application is a continuation of International Application No. PCT/NL2023/050342, entitled “A CHARGING CONNECTION SIMULATOR PLUG AND A VEHICLE”, filed Jun. 19, 2023, which claims priority to and the benefit of Netherlands Patent Application No. 2034533, entitled “A CHARGING CONNECTION SIMULATOR PLUG AND A VEHICLE”, filed Apr. 11, 2023, and the specifications and claims thereof are incorporated herein by reference.

### BACKGROUND OF THE INVENTION

### Field of the Invention

The invention relates to a charge plug for an external electrical charging port of an electric vehicle. It should be understood that external means ports provided outside of the cabin.

### Background

A blind plug for an electric vehicle is a well-known technical term, also known as a “Blindstopf”, and is known from German patent DE 10 2013 005 072 B3. It should be clear that a blind plug is in fact a cover plug that prevents the transmission of electrical energy. This is not to say that the plug itself cannot have an electrical interaction with a contact, read charging port. A dummy plug is in the context of this invention to verify a plug that is incompatible with the electrical charging of an electric vehicle. This is in contrast to the usual charging plugs men use to charge vehicles.

Dummy plugs are used so that the charging port cover of a vehicle can be closed while tricking the vehicle into thinking its cover is open. This allows internal system to be accessible via the cabin in a display setting, while allowing the car to maintain its slick design.

Electric vehicles are nowadays designed to protect themselves against driving away, such as by applying a brake, when they are charging at a charging station. Only in some instances a blind plug will work as an anti-start unit. However, should the car already be started, such blind plugs cannot be used to reliably prevent the car from driving. The advantage of current electric vehicles in Europe uses one of the following charging port types: Type 1 Yazaki, SAE J1772, IEC 62196-1, this charging port is the Japanese standard for AC charging and is also adopted in the US and accepted in the EU. This kind connector can be used by car models such as: Opel Ampera (previous version), Nissan Leaf, Nissan E-NV200, Mitsubishi Outlander, Mitsubishi iMiev, Peugeot iON, Citroen C-Zero, Renault Kangoo ZE, Ford Focus electric, Toyota Prius Plug in and KIA SOUL; NL Type 2, IEC 62196-2, this charging port has been designated by the European Commission as a standard for regular charging ((≤22 KW) of electric cars. This type of connector can be used by car models such as: Opel Ampera (new version) BMW i3, i8, BYD E6, Renault Zoe, Volvo V60 plug-in hybrid, VW Golf plug-in hybrid, VW E-up, Audi A3 E-tron, Mercedes S500 plug-in, Porsche Panamera and Renault Kangoo ZE.

Other types of charging ports are also known, such as the Type 3 Combined Charging System, also known as CCS Combo 2, the Type 4 CHAdeMOx and the Type 5 Tesla Supercharger.

As more electric vehicles hit the road, people are more likely to see such electric vehicles being involved in an accident. It can then happen that the motor of an electric vehicle is accidentally not switched off by a driver. This can have life-threatening consequences. There is therefore a desire to easily protect electric vehicles against starting the engine after accidents, and to be able to prevent this by using as many different vehicles as possible without having to carry an enormous amount of different plugs.

Currently, vehicles are seen on the road which are fully unresponsive to PP-based communication. In particular popular Chinese brands are developed in such a manner. Accordingly, a anti-locomotion means beyond a simple anti-start PP-communication is desirable, wherein such unit should be universally functional across different vehicle types with different internal safety programming.

Discussion of the references above and throughout this application is given for more complete background and is not to be construed as an admission that such publications are prior art for patentability determination purposes.

### BRIEF SUMMARY OF THE INVENTION

Embodiments of the present invention are directed to a charging connection simulator plug for fitting an external electric charging port of an electric vehicle, wherein the plug is designed for simulating a connection to a charging station through its electrical contacts by comprising an electrical resistance associated with its PP and/or PE contact, and a circuit for CP communications associated with its CP contact, for generating Pulse-width modulation (PWM) signals and optionally designed to modulate signals over a PWM-signal for Power Line Communication, wherein the plug is fully incompatible with the charging of the electrical vehicle. To enable PWM-signal generation by the plug itself the plug may comprise its own power source, disposed anywhere there within.

Fully incompatible means at least one of the following:
i) the plug comprises a body which prevents the unification with an electrical cable itself designed for charging an electric vehicle, and wherein the plug does not comprise internal or external electrical connection portions which are designed for receiving an electrical cable to restore such ability to charge the electrical vehicle; and
ii) the electrical wiring within the plug is unsuitable for supporting the charging of the vehicle. Feature i) being preferable in design, for it saves on components and prevents accidents by which the plug is rendered useless.

Embodiments of the present invention are also directed to a charging connection simulator plug for fitting an external electric charging port of an electric vehicle, wherein the plug is designed for the simulation a connection to a charging station through its electrical contacts by comprising an electrical resistance associated with its PP and/or PE contact, and a circuit for CP communications associated with its CP contact, for generating Pulse-width modulation signals, wherein the plug is designed for mediating the charging of an electric vehicle therethrough, so as to allow the plug to serve as a simulator when the plug is not used for charging. Beneficially the plug is allowed to act as simulator when no charging station is connected while also allowing the plug to be used for charging when a charging station is connected, making the plug very multifunctional.

Optionally, the latter of the two plugs can be designed to act as an adaptor in combination with a charging cable comprising its own charging plug for an electric vehicle.

Optionally, either of the plugs has a head that is modularly interchangeable, such as by removal from a body comprising a handle, for changing the suitability of said plug to mutually different vehicles. Further optionally, the plug head may be designed as a stack of mutually different plug heads, and wherein the mutually different plug heads are removably connectable to each other to change the compatibility of the plug with a vehicle. In the example of the first plug, which is incompatible with the charging of a vehicle, each of the mutually different plug heads of the stack may be designed without functional single-phase AC and/or Neutral connector parts.

Either of the plugs may be designed to correspond information relating to the status of the battery, such as over-temperature, as this information may be accessible via the charging protocol used by the vehicle. This information can be communicated to a user via a display or light indicator provided thereon.

The plug may additionally, or alternatively be provided with a wireless communication arrangement, such as a wireless transmitter-receiver suitable for mobile telephone communications or WiFi, so as to communicate the information to a distal server or device.

A light indicator may be provided as a translucent portion of the body, preferably of the handle of the body, with a light source, such as an LED.

It is believed that in the future it will be useful to access onboard diagnostic information, such as information directly associated with markers for a thermal runaway. This includes a battery over-temperature, such as over 70 degrees Celsius, but also the status of the High voltage circuit, and whether or not the engine may still come alive. It is therefore believed that an Onboard Diagnostic (OBD) port, such as an OBD-II port, may be beneficially provided to the vehicle. Any OBD-port may suffice, but the OBD-II port appears to be the most useful. Accordingly, the plug may further comprise an OBD connector portion designed for connecting to an OBD-port, for retrieving data associated with the battery of the vehicle and/or status of the brakes and gear, and optionally designed to communicate a command to the vehicle to assume shift to neutral and to engage the brakes.

In one design the plug can be modular. This allows for the partial replacement of parts which suffer the most wear. It may also allow the plug heads to evolve, such as when new charging port types come to market, while allowing the plug body itself to be updated by means of software. This ensures the longevity and usefulness of the plug. Accordingly, optionally the plug can comprise a first head compatible with a first charging port that is removably attached to the body.

While it's possible for different plug heads to be part of different distal ends of the plug body, it is equally possible for a plug to comprise a second head compatible with a second charging port to which the first head is connectable as an adapter, and wherein optionally the first and second charging port are mutually different. This means that the plug can adapt to any car's charging port type by simply adding to or removing a plug head from the plug. This is quick and allows first responders to not lose a second of time while securing a vehicle.

In one example the plug comprises a second head, optionally designed for removably covering the first head or vice versa, and wherein the second head comprises the OBD-connector portion.

In yet another embodiment the first plug head slide connects with the body of the plug, comprising a handle, and wherein the plug body comprises an electrical connection slot for connecting the pins of the first plug head to internal circuitry disposed within the handle. The plug can be designed so that the head slide clicks into position in a motion that that is substantially perpendicular to the direction in which the plug head is moved into or out of the charging port of the vehicle. Substantially perpendicular is 70-110°, preferably 85-95°.

Alternatively, the first plug head slide connects with the body of the plug, comprising a handle, and wherein the plug body comprises an electrical connection slot for connecting the first plug head to internal power source disposed within the handle, wherein the circuitry for providing at least CP communication is disposed within the first head.

Optionally, the plug comprises a digital display, wherein the plug is programmed for providing instructions and/or communicating a successful PP and/or CP connection with the vehicle to the user of said plug via said display, wherein the display is optionally recessed in a portion of the body of the plug. The latter option prevents damage to the screen.

It is also possible for plug to comprise an NFC antenna for pairing with an external device, and wherein the plug is programmed to communicate information about the connection state of the plug with the vehicle, and optionally information about the battery and/or information about the status of the brakes, engine and gears of the vehicle.

In addition, the plug may be programmed for a user verification step via a paired device, wherein the plug is designed such that the simulation of the connection to a charging station, namely PP and/or CP connection simulation is conditional on the verification step being successfully performed. This prevents misuse of the platform, such as for carjacking.

Optionally, the plug comprises a light indicator, such as an LED indicator, for displaying the connection status of the plug with the vehicle in mutually different colors, wherein the status comprises: a failure to establish a communicative connection to a vehicle and a successful communicative connection to a vehicle, and wherein said light indicator is optionally provided at a distal end of the plug body, or designed so as to curve with a portion of the contour of the body of the plug. The communicative connection may be a PP and/or CP connection.

There is yet more. Because the plug may be provided with a rechargeable battery as its power source, such as a lithium-ion battery. The plug may comprise a battery compartment which can be manually accessed, such as by the removal of a cap, preferably from a lateral side of the body, and wherein said compartment comprises the power source of the plug. A part of the body such as the handle is preferably bent such as with an angle 40-90°, preferably 50-70°, so as to not project too far from the vehicle while plugged in. The distal part of the plug body is designed as a handle with at least one substantially flat surface housing the Near-field communication (NFC) antenna there under for allowing for easy pairing through inductive coupling.

In order to prevent theft or loss of the plug, the body may be provided with a tie-down eye. This allows the plug to be connected to the cover of the charging port of the vehicle so that it can remain in place. In the event of workplace buffoonery, the deliberate disconnection of the plug, the plug may additionally be designed to make an alarm sound, such as via a speaker which can be deactivated by the user, such as via a button, like a short pressing of a power button. Alternatively, or additionally the plug may also signal its non-connectivity using its light indicator.

Instead of a speaker or in addition to a speaker a buzzer may be comprised within the body of the plug, wherein the buzzer comprises its own resonance box.

It is envisioned that in the future electric vehicles will communicate the detection of errors associated with the battery to the charging stations. The plug may therefore be arranged and programmed to detect signals which are indicative of such errors. In fact, the plug may be designed for detecting an emergency signal sent by the vehicle over the CP-line corresponding to a detected battery damage, impending thermal runaway, or active thermal runaway, by said vehicle and wherein the plug is designed to issue an alarm via a light indicator, a display and/or a speaker comprised therein.

Optionally, the plug comprises a USB port for allowing the charging of a power source of the plug, and wherein optionally the plug is designed for allowing the plug to receive software updates through said USB-plug.

In one example, which is compatible with any of the embodiments the plug may also be designed to simulate a connection with a vehicle for a charging station, or be programmed and designed for performing a diagnostic test on the charging station, when connected thereto. Such diagnostic testing may comprise at least one of the following, but preferably at least *:
Testing mains supply and grounding
   Testing GFCI operation, GFCI being the ground-fault circuit interrupter Capturing full PWM information
   Testing insulation of charging cables
   Simulating vehicle faults
   Testing venting systems where fitted
   Testing supply voltage
Testing maximum available charging current

It should be clear that a plug that is unsuitable for charging may be plugged into the charging socket of a charging station or attached to an end of its charging cable, such as by means of an adapter portion. The plug would also separate from this example be provided with a programmable circuit board that is programmed for at least one simulation. In the example of the plugs suitability for running charging station diagnostics the plug will be programmed to switch between a simulation mode for the vehicle, namely its connection to a charging station, and a simulation mode for the charging station, namely its connection to an electric vehicle. Alternatively, the simulation mode for the charging station is a diagnostic mode. A further diagnostic mode may be present when the plug is provided with an OBD-connector. In such case the plug may namely be programmed to retrieve information from the Battery Management System (BMS) of the vehicle regarding the status or markers of the status of the high voltage battery bank of said vehicle. This can optionally be a separately selectable mode of the plug. It should go without saying that the plug may comprise, also separate from this example, a human interface such as a button, selector touch screen for allowing a user to switch between modes, and/or to allow a user to test or verify the communicative CP-connection of the plug with a vehicle.

In yet another option the plug may be provided with an RFID reader, for reading an RFID tag, and is connectable to the internet via a receiver-transmitter comprised in said plug for wireless communications to a distant server and to access a database therein. The plug is in this example programmed to reference the database to establish the validity of an RIFD tag presented to the plug to enable either CP-communications by the plug, or to enable any simulation for which the plug is programmed. This prevents carjacking using the device.

In yet another scenario, the plug may be provided with a biometric signature reader for biometric authentication of a user, wherein functionalities, such as CP-communications, or any simulation, are only enabled upon successful authentication of the user's signature.

Also possible is that the plug comprises a display which is a touch screen, and wherein the plug is programmed so that functionalities, such as CP-communications, or any simulation, are only enabled upon the user successfully entering a code. The plug may be designed so as to disable said functionalities upon instruction of a user, such as via said display, or by powering down. To this end a power button may also be provided to the body of the plug. PP-functionality may also be disabled by interrupting the internal connection between PP and PE contacts present in the first head.

It was noted that inductive charging may provide an additional angle of approach for safeguarding a vehicle. To this end the plug may comprise a wireless transmitter-receiver, wherein the plug is programmed for communications with the electric vehicle, such as according to SAE J2847/6 or ISO/IEC 15118-7 so as to simulate, for the vehicle, communications with a wireless charging station. This wireless transmitter-receiver may be part of a wireless communications arrangement for other communications, or a different wireless transmitter-receiver separately furnished within the body of the plug.

Optionally, the plug comprises a G-sensor, such as a 3G-sensor (not shown, but customary). The plug may be programmed to alert the user if it detects movement of a vehicle while connected to a charging port, or, if applicable, to an OBD-port. An alert may be emitted by buzzer, speaker, display, light indicator or by sending a wireless message to a paired device and/or server. This depends on the features provided to the plug.

Embodiments of the present invention are also directed to a vehicle comprising an electrical charging port for the high voltage battery system of said vehicle, wherein the charging port itself comprises an OBD-port or wherein the vehicle is designed to emit an emergency signal over the CP-line when the battery management system of the high voltage battery pack of the vehicle detects signs of battery damage, imminent thermal runaway or active thermal runaway.

In one example the charging port comprises an OBD-port recessed in the same face, preferably the same surface portion, as charge connector portions of the charging port. Optionally a plug can be designed to have an OBD and charging port connector provided any of the plug heads, such that the charging port can be connected for CP and OBD communication in a single motion. Optionally or alternatively, the OBD connector comprises in the plug can be designed so as to be retractable within the plug head, or provided as part of a cable attached to the plug head or body of the plug. Beneficially, this allows a user to plug the OBD connector in an OBD-port of a vehicle regardless of the location of the OBD-port on the charging port, which may differ between vehicles in the future. Separately from the above it is reiterated that the plug may comprise a rechargeable power source, such as a lithium-ion battery. To improve the comfort of use the plug may comprise a portion suitable for receiving electrical energy for charging the power, such as a USB port and/or inductive charging coil, and wherein preferably said portion suitable for receiving electrical energy is furnished at the distal end of the handle, such as recessed in a portion of the handle on an opposite side of a substantially flat surface of the handle.

To provide further convenience a docking station is considered for recharging a plug, wherein the station is provided with a platform comprising a portion for providing electrical energy to the charging portion, such as a USB connector and/or inductive charging coil, and wherein the station comprises a standard projecting from said base, preferably integral with said base, for maintaining the plug in a predefined orientation, such as an upright orientation, and wherein optionally the station is provided with a recess wherein the charging portion is arranged, and wherein the recess is designed for a snug fit with the distal end of the handle. The docking station may itself comprise a cable for connecting it to the electrical grid via an ordinary power socket.

An assembly of plug docking station, in which the plug handle is provided into said recess for a stable electrical connection is also considered herein.

Embodiments of the present invention are also directed to a charging port for the vehicle.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is an illustration showing a side view of a plug according to an embodiment of the present invention;

FIG. 2 is an illustration showing an exploded view of a plug according to an embodiment of the present invention;

FIG. 3 is an illustration showing a perspective view of the plug illustrated in FIGS. 1 and 2, to show its modular nature;

FIG. 4 is an illustration showing a perspective close-up view of the curved handle of an embodiment of the present invention;

FIG. 5 is an illustration showing a perspective view of a plug connected to the charging port of a vehicle according to an embodiment of the present invention;

FIG. 6 is an illustration showing a perspective view of a charging port of a vehicle according to an embodiment of the present invention; and

FIG. 7 is an illustration showing a perspective view of an assembly of a docking station and a plug according to an embodiment of the present invention.

### DETAILED DESCRIPTION OF THE INVENTION

While it is noted that the Figures only show a plug that does not suitable for charging, the features discussed herein are also applicable to a plug that is.

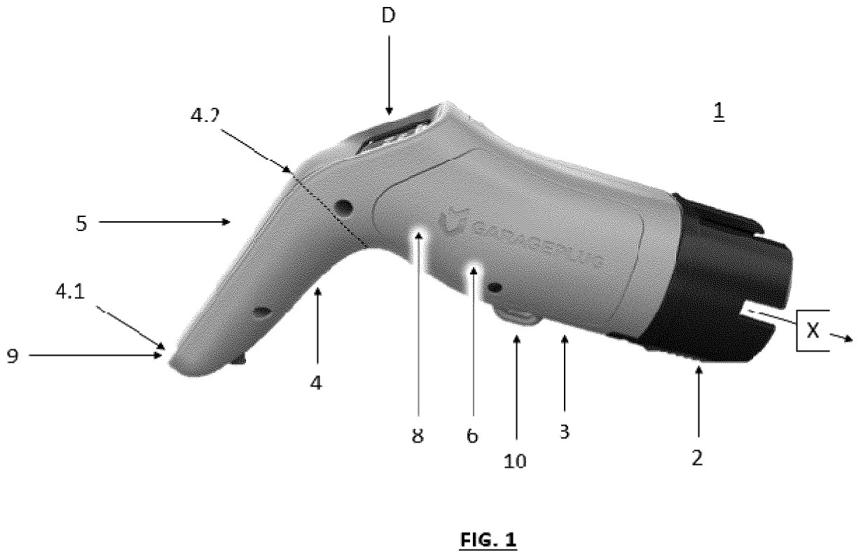

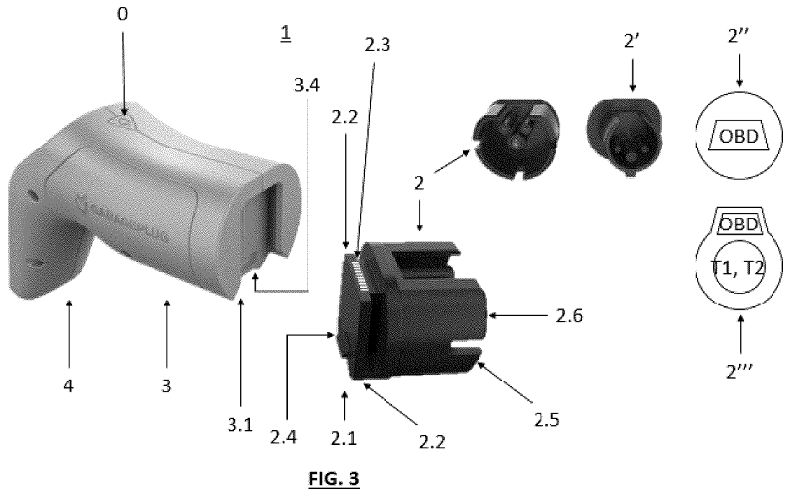

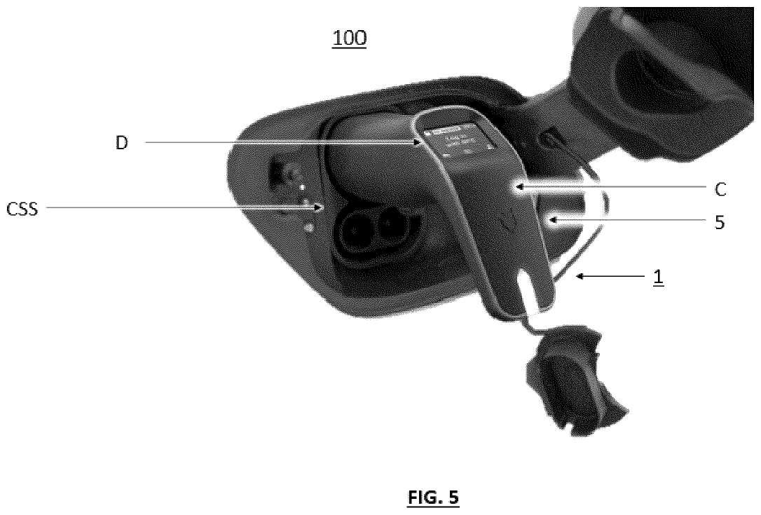

FIG. 1 shows charging connection simulator plug 1 for fitting an external electric charging port 101, see FIG. 5. The plug comprises a slidably detachable first plug head 2, also referred to as a first head, corresponding to type 1, and body 3 comprising handle 4. The handle comprises a bent portion which projects at an angle from the rest of the plug body. First plug head 2 can be removably connected by sliding perpendicular to the longitudinal direction X of plug body 3 so as to not dislodge head 2. Direction X is in this example the same direction as the direction of motion for inserting the plug into charging port 101. First plug head 2 is designed to snap fit with the body. This is best shown in FIG. 3 which shows first plug head 2 and body 3 each comprising corresponding portions 2.1, 3.1 for guiding the reversible attachment of first plug head 2 with body 3. The person skilled in the art will understand that there are many other ways to go about this, and that first plug head 2 may also be provided as a stack of heads, wherein only one plug of the stack comprises portion 2.1, and another plug being an adapter changing the compatibility of the plug between charging port types, such as type 1 or type 2.

In order to help secure the plug a tie-down eye 10 is a part of the body, in this example on a lower face of body 3, and expressly not a part of the portion of the body forming handle 4, so as to prevent accidental manipulation of any element connecting to said tie-down eye while in use.

FIG. 1 shows body 3 comprising handle 4 with a substantially flat surface 5.

Substantially flat means any surface for which the degree of curvature is no greater than 5°, preferably no greater than 2° considering the following equation:

R=180° A/pi*D_{C}
Wherein:
R=radius of the curvature
A=arc length
D_{C}=degree of curvature

Handle 4 can be designed so that surface 5 faces away from the vehicle when the plug is connected to a charging port. The above design suitably prevents the plug from sticking out too far, and taking up too much space.

Also separately from the detailed description and compatible with all embodiments FIG. 1 shows that flat surface 5 extends between distal end 4.1 of handle 4 and to digital display D, preferably from distal end 4.1 to bending point 4.2 in the handle leading to display D, and wherein optionally light indicator 9 is furnished as a portion of surface 5, and preferably extends from distal end 4.1 along a portion of surface 5.

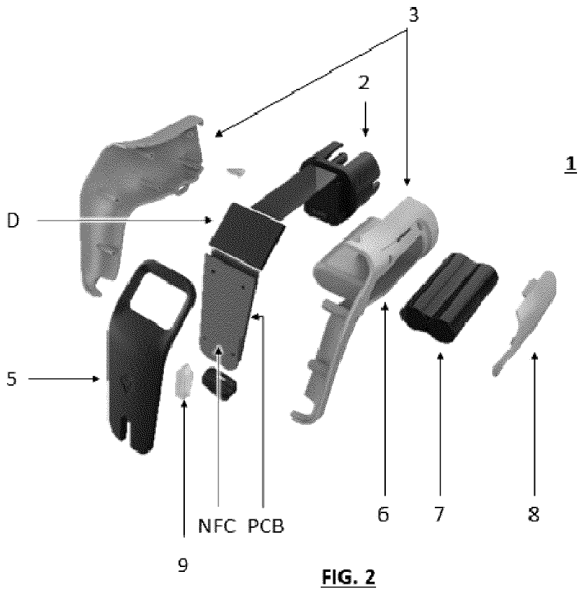

The surface may comprise 15-40% of the total surface of the handle of the body, wherein the handle surface is the surface of the body below bending point 4.2 until the distal end 4.1. A dotted line marks the extent of the handle surface. In FIG. 2 it can be seen that handle 4 may house an NFC-antenna NFC underneath surface 5 for pairing the plug with external devices.

FIG. 2 further shows that the plug comprises an electronic circuit, this can be read as a preprogrammed printed circuit board PCB and is here and there also referred to as simply, the circuit. The PCB comprises both a memory, a processor and a PWM signal generator (not shown, but customary). Alternatively, the PWM signal generator is provided separately from the PCB, but communicatively connected to the PCB. The PCB or PWM signal generator can be designed to modulate signals over a PWM-signal for Power Line Communication. In the vehicle's charge control module, a Transmission Control Protocol or Internet Protocol (TCP/IP) stack is used for communication. This allows the plug to use high-level communication in a Combined Charging System (CSS_. This portion can also be taken separately from this example. The person skilled in the art understands CSS being a standard for electric cars.

It should be clear that the plug may also be programmed for both Low-Level Communication and High-Level Communication via the CP contact, wherein Low-Level comprises information on:
Maximum current which the cable can handle;
Charging state, such as
   is there a connection; and/or
   is the vehicle ready to charge?

Whereas, the high-level communication comprises at least one of:
Charging sequence;
Compatibility; and
Physical limits, such as energy demand.

Body 2 may also be seen to comprise battery compartment 6. FIG. 2 shows that the battery may be provided in a separate internal space within the body, such that the battery, that is to say power source 7, can be accessed when removing cover 8 from the body without giving a user access to the circuitry of the device. This prevents accidental damage when replacing power source 7.

FIG. 3 shows more specifically the interchangeability of the first plug head. Here first plug head 2 can be seen to comprise connector portion 2.1, for connecting to body 3, on its rear end. This connector portion 2.1 comprises two protruding edges 2.2 each of which extend from a lateral side of the connector portion opposite the other. The edges correspond with a corresponding connector portion 3.1 of the body comprising a guide. An electrical contact portion 2.3 extends between the protruding edges, or is provided along a surface of the connector portion which extends substantially perpendicular to the direction in which the protruding edges slide connect with the body. In this manner friction contact does not affect the electrical contact portion 2.3 between body and first plug head.

Optionally, protrusion 2.4 on the rear of connector portion 2.1 corresponds to recess 3.4 on connector portion 3.1 of plug body 3. The recess is itself provided within a recess for receiving connector portion 2.1. The first head can thus beneficially be slid into the body such that 2.4 and 3.4 connect so as to secure the first plug head from sliding off. This ensures that the electrical communication between plug head and body is maintained. The protrusion is designed with a small slope and/or between about 0.5-5 mm, preferably about 1-2 mm in size, so that manual application of force, such as a force greater than about 5-100 Newton, preferably about 10-50 N, exerted on the first head, in the direction for sliding the head off of the plug body allows a user to disconnect the head from the body.

FIG. 3 also shows, separate from the above that second plug head 2′ of another type, here type 2, can be provided instead. In this example, second plug head 2′ comprises the same connector portion 2.1 as the first plug head on its rear end. In another example, though not shown here, the second plug head can be designed so as to form a stack with the first plug head, to this end second plug head is a type 1 to type 2 adapter.

Optionally, first plug head 2′, and/or second plug head 2′, comprises skirt 2.5 surrounding the electrical contacts for connecting to the charging port of a vehicle, which is designed to prevent a locking connection with a charging port of a vehicle. That is to say, skirt 2.5 comprises multiple recesses which extend to the distal end of said skirt while, such that the front view of the plug head remains mirror symmetric.

Yet more alternative plug heads may comprise plug head 2″ with only an OBD-connector, or plug head 2″ with both an OBD-connector and any other type, such as type 1 T1 or type 2 T2 connector for an electric vehicle. In the case of these plugs the skirt 2.5 may or may not be present. It is beneficial to have the skirt so as to provide stability to the more fragile OBD-connection, so that the skirt may support the weight of the plug instead of the OBD-connector port of a vehicle. In one embodiment, not shown herein, the OBD-connector may be moveably arranged on plug head 2″, such as by cable. This allows the plug head to be universal and may also allow the OBD-connection to be made first optionally followed by connecting the skirt to the charging port of the electric vehicle.

FIG. 3 shows power button 0. The plug is programmed to test PP and/or CP connection with a vehicle in response to a user manipulating said power button. Alternatively, the plug may be programmed such that the power button activate or deactivate a PWM-signal, such as also comprising an overlaid signal, and optionally simultaneously respectively restoring or interrupting the electrically conductive connection between PP and PE pins internally.

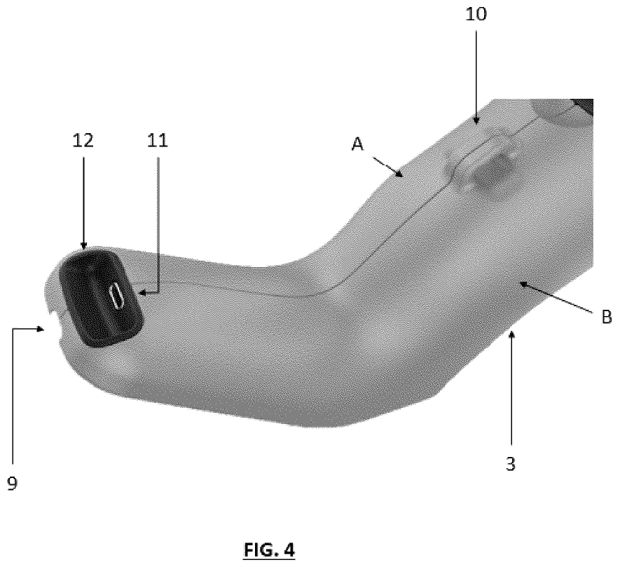

FIG. 4 shows that body 3 comprising handle 4, comprises at distal end of handle 4 USB-port 11, such as for recharging power source 7 of the plug. The power source is shown in FIG. 2. In this example, the USB-port is provided in recessed ledge 12. So as to protect the port in case of water damage, in case the plug is laid down on a wet surface.

FIG. 4 also shows, separate from the before mentioned that body 3 is recessed directly underneath tie-down eye 10. So that the presence of the recess increases the diameter of the through hole of the tie-down eye, and wherein preferably the recess is formed by an inward deflection of a portion of body 3 towards battery compartment 6, such as shown in FIG. 3.

FIG. 5 shows that the plug body is designed such that a display, a light indicator, and optionally a surface, such as surface 5, underneath which an NFC-antenna is housed, are integrated within a single body portion C forming a part of the handle 4, and wherein body 3 of the plug is comprised of two sides A, B, as shown in FIG. 4, which are assembled with portion C to form a housing. FIG. 5 also shows the plug being connected to a combined charging system CSS.

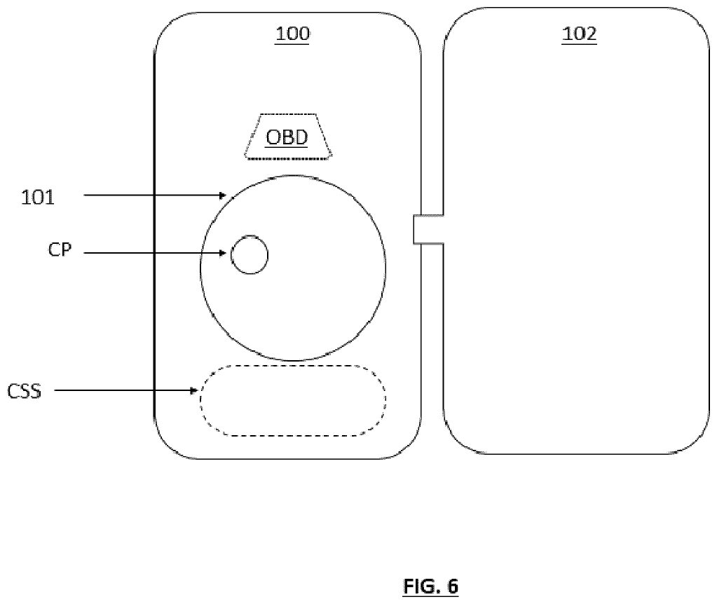

FIG. 6 shows a possible design of a new charging port 100 of a vehicle provided with an OBD-port, such as an OBD-II port. The charging port comprising a conventional charging port 101, and may be a CSS charging port comprising features of type 1 or type 2 charging port with DC charging features. This is reflected by the dotted lines, which indicate the optionality of this portion. Conventional charging port 101 here may have a PP, PE and CP connection port.

In this example closable cap 102 is designed for reversibly covering both the OBD and conventional charging port upon closing.

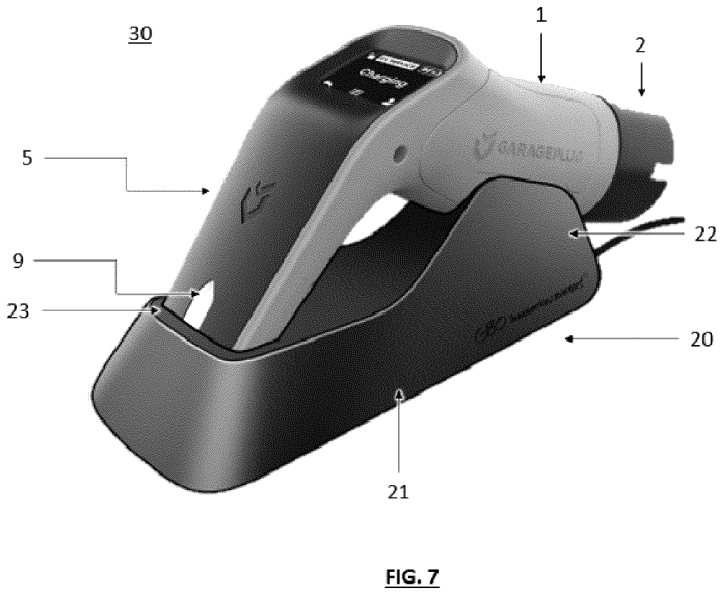

FIG. 7 shows an assembly 30 of plug 1 and docking station 20 for recharging plug 1. Station 20 is provided with platform 21 comprising a portion for providing electrical energy to the charging portion, such as a USB connector and/or inductive charging coil, (not shown but customary). Station 20 has standard 22 projecting upwards from said base, in this example integral with said base, for maintaining the plug in an upright orientation. The station is provided with recess 23 wherein the charging portion is arranged, and wherein the recess is designed for a snug fit with the distal end of the handle, but wherein also separate from this example the recess is designed such that a portion of the indicator light remains visible. In this example the plug may also be programmed to indicate by means of the display and/or color of the indicator what the charging state is, such as complete or charging. The docking station may further optionally be provided with an internet connection port, and wherein the plug is designed to receive updates via the docking station.

The plug can be designed as a charge connection simulator for setting up digital communication, such as PLC and/or LIN-CP, with the vehicle the plug designed to:
support the PP, such as with 100 Ohm and/or 70 Ohm resistance (Rc) comprised in the plug, such as for single phase DC charging support CP PWM generation, by a circuit board comprising a processor, comprised in the plug;
optionally support a release button comprised in the plug, for releasing the plug from the charge port, when the charge port locks the plug;
support PLC Communication according ISO/IEC 15118/SAE J2847, by said circuit board and/or support LIN-CP Communication according IEC-61851/SAE J3068, by said circuit board;
wherein the simulator is designed for the following when connected to the charge port of an electric vehicle:
Establish PP connection with a vehicle;
Establish CP connection with the vehicle, such as with 1-20%, preferably a 2-10% duty cycle, and even more preferably a 5% duty cycle, as this may beneficially improve the longevity of the device;
Check CP Status indication that correct connection is established, such as by circuit board; and
optionally displaying said correct connection using an indicator, such as an LED or display, comprised in the plug.
wherein further optionally, the simulator is programmed to leave the CP connection is open, such as when communicative contact with a vehicle is established.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another. The terms, “a”, “an”, “the”, and “said” mean “one or more” unless context explicitly dictates otherwise.

Note that in the specification and claims, “about” or “approximately” means within twenty percent (20%) of the numerical amount cited.

1. A charging connection simulator plug comprising a body and a first head for fitting an external electric charging port of an electric vehicle, wherein the plug is designed for simulating a connection with a charging station through its electrical contacts by comprising an electrical resistance associated with its PP and/or PE contact, and an electronic circuit for CP communications associated with its CP contact, designed for generating Pulse-width modulation signals and optionally designed to modulate signals over a PWM-signal for Power Line Communication, wherein the plug is fully incompatible with the charging of the electrical vehicle, wherein the first head comprises electrically conductive contacts, wherein these conductive contacts optionally exclusively consist of a PP, a CP and a PE contact, wherein the plug comprises a human interface such as a button, selector or touch screen for
allowing a user to switch between modes,
and/or
to allow a user to test or verify the communicative CP-connection of the plug with a vehicle.

2. A charging connection simulator plug comprising a body and a first head for fitting an external electric charging port of an electric vehicle, wherein the plug is designed for simulating a connection with a charging station through its electrical contacts by comprising an electrical resistance associated with its PP and/or PE contact, and an electronic circuit for CP communications associated with its CP contact, designed for generating Pulse-width modulation signals and optionally designed to modulate signals over a PWM-signal for Power Line Communication, wherein the plug is designed for mediating the charging of an electric vehicle therethrough, so as to allow the plug to serve as a simulator when the plug is not used for charging, optionally the plug is designed to act as an adaptor in combination with a charging cable comprising its own charging plug for an electric vehicle.

3. The plug according to claim 1, wherein the plug further comprises an OBD connector portion designed for connecting to an OBD-port, for retrieving data associated with the battery of the vehicle and/or status of the brakes and gear, and optionally designed to communicate a command to the vehicle to assume shift to neutral and to engage the brakes.

4. The plug according to claim 1, wherein the first head is compatible with a first charging port and wherein said first head is removably attached to the body slidably in a direction substantially perpendicular to a direction of insertion of the plug into the electric charging port.

5. The plug according to claim 4, wherein the plug comprises a second head compatible with a second charging port to which the first head is connectable as an adapter, and wherein the first and second charging port are mutually different.

6. The plug according to claim 3, wherein the plug comprises a second head designed for removably covering the first head or vice versa, and wherein the second head comprises the OBD-connector portion.

7. The plug according to claim 1, wherein the first head slide connects with the body of the plug, comprising a handle, and wherein the plug body comprises an electrical connection slot for connecting the pins of the first head to internal circuitry and power source disposed within the handle.

8. The plug according to claim 1, wherein the first head slide connects with the body of the plug, comprising a handle, and wherein the plug body comprises an electrical connection slot for connecting the first head to an internal power source of the plug disposed within the handle, wherein the circuitry for providing at least CP communication is disposed within the first head.

9. The plug according to claim 1, wherein the plug comprises a digital display, wherein the plug is programmed for providing instructions and/or communicating a successful PP and/or CP connection with the vehicle to the user of said plug via said display, wherein the display is recessed in a portion of the body of the plug.

10. The plug according to claim 1, wherein the plug comprises an NFC antenna, disposed underneath a surface portion as a substantially flat surface portion of the handle, for pairing with an external device, and wherein the plug is programmed to communicate information about the connection state of the plug with the vehicle, and information about the battery and/or information about the status of the brakes, engine and gears of the vehicle.

11. The plug according to claim 10, wherein the plug is programmed for a user verification step via a paired device, wherein the plug is designed such that the simulation of the connection to a charging station, namely PP and/or CP connection simulation is conditional on the verification step being successfully performed.

12. The plug according to claim 1, comprising a light indicator for displaying the connection status of the plug with the vehicle in mutually different colors, wherein the status comprises: a failure to establish a communicative connection to a vehicle and a successful communicative connection to a vehicle, and wherein said light indicator is optionally provided at a distal end of the plug body, or designed so as to curve with a portion of the contour of the body of the plug.

13. The plug according to claim 1, wherein the plug comprises a battery compartment which can be manually accessed from a lateral side of the body, independently of the rest of the body, and wherein said compartment comprises the power source of the plug.

14. The plug according to claim 1, wherein the body comprises a tie-down eye.

15. The plug according to claim 1, wherein the plug is designed for detecting an emergency signal sent by the vehicle over the CP-line corresponding to a detected battery damage, impending thermal runaway, or active thermal runaway, by said vehicle and wherein the plug is designed to issue an alarm via a light indicator, a display and/or a speaker comprised therein.

16. The plug according to claim 1, comprising a USB port for allowing the charging of a power source of the plug, and wherein optionally the plug is designed for allowing the plug to receive software updates through said USB-plug.

17. The plug according to claim 1, wherein:
the plug is also designed to simulate a connection with a vehicle for a charging station
and/or
the plug is programmed for performing a diagnostic test on the charging station, when connected to a charging station.

18. The plug according to claim 1, wherein the plug comprises a rechargeable power source, wherein the plug comprises a portion suitable for receiving electrical energy for charging the power, and wherein said portion suitable for receiving electrical energy is furnished at the distal end of the handle.

19. The plug according to claim 1, wherein the plug comprises a wireless transmitter-receiver, wherein the plug is programmed for wirelessly communicating with the electric vehicle to simulate wireless charging communications by a wireless charging station.

20. A docking station for recharging a plug according to claim 19, wherein the station is provided with a platform comprising a portion for providing electrical energy to the charging portion, and wherein the station comprises a standard projecting from said base for maintaining the plug in a predefined orientation, and wherein the station comprises a recess wherein the charging portion is arranged, and wherein the recess is designed for a snug fit with the distal end of the handle.

21. An assembly of a plug according to claim 19 and a docking station according to claim 20.

22. A vehicle comprising an electrical charging port for the high voltage battery system of said vehicle, wherein the charging port itself comprises an OBD-port or wherein the vehicle is designed to enable PCM, ECM, and/or BMS communications over the CP-port in response to a detected error associated with the high voltage battery system or high voltage system of said vehicle, wherein optionally the signal is a PWM-signal or a signal modulated over a PWM-signal for Power Line Communication.

23. The vehicle according to claim 22, wherein the charging port comprises an OBD-port recessed in the same face as a conventional charging port, as charge connector portions of the charging port.

24. A charging port according of the vehicle according to claim 22.
